(19) United States
(12) Patent Application Publication
(10) Pub. No.: US 2005/0261998 A1
(43) Pub. Date: Nov. 24, 2005

(54) Computerized system and method for valuating employee stock options

(76) Inventors: Antonio Manuel Possolo, Niskayuna, NY (US); Brock Estel Osborn, Niskayuna, NY (US); Kathleen Marie Skumurski, Clifton Park, NY (US); Mariano Sebastian Weil, Waterbury, CT (US); Mitchell Anthony Danaher, Trumbull, CT (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/849,480

(22) Filed: May 19, 2004

(51) Int. Cl. G06F 17/60

(52) U.S. Cl. 705/35

(57) ABSTRACT

Computer system and method for performing valuation of stock options issued by a corporation to employees are provided. The computer system may comprise a historical employee stock option database populated with information regarding employee stock option awards issued by said corporation. The computer system may further comprise a historical stock price database populated with historical stock prices and dividends, if any, issued by that corporation. An employee database may be populated with information regarding employees who have been issued stock options. A first data feed may provide present stock prices of the corporation. A second data feed may provide present risk-free interest rate structure. A processor may be configured to extract from data stored in the databases at least one historical-based parameter affecting a valuation of employee stock options. A user interface may be used for communicating with the processor and perform a valuation of employee stock options at least in part based on the at least one historical-based parameter.

### BACKGROUND OF THE INVENTION

The present invention is generally related to computerized techniques for valuating financial assets, and, more particularly, to computerized techniques for valuating employee stock options.

The accurate valuation of employee stock options is a key concern for many corporations. Due to increased scrutiny of financial accounting disclosure practices by regulating boards, the fair present value, at time of grant, of employee stock options that may be exercised in the future needs to be accurately determined for appropriate reporting on corporate balance sheets. Furthermore, since employee stock options are used to compensate and retain highly valued executives and other employees, there is an increasing need to determine their overall value for the business as compared with other forms of employee incentive and compensation.

There are several known algorithms for performing valuation of exchange tradeable stock options, such as Black-Scholes, Binomial Lattice, and various Monte Carlo techniques. It is believed, however, that none of such algorithms has been designed to systematically address the specifically distinctive features of employee stock options, including their relatively long nominal life (as compared to exchange-traded options), vesting restrictions, forfeiture, non-transferability, and patterns of early exercise driven by employee demographics and other influencing variables.

Furthermore, conventional models typically make assumptions about the evolution of stock prices that empirical evidence has shown may be grossly inadequate in diverse historical, and economic scenarios. In addition, the complex dynamics involving the interaction of a multiplicity of variables that can influence fair value of employee stock options demand that the process of extracting information from historical data sources be integrated with accurate financial and statistical analysis procedures in order to translate past stock performance and historical employee option exercise information into valuable knowledge.

### BRIEF DESCRIPTION OF THE INVENTION

Generally, the present invention fulfills the foregoing needs by providing in one aspect thereof, a computer system for performing valuation of stock options issued by a corporation to employees. The computer system may comprise a historical employee stock option database comprising information regarding employee stock option awards issued by said corporation. The computer system may further comprise a historical stock price database comprising historical stock prices and dividends, if any, issued by that corporation. An employee database comprises information regarding employees who have been issued stock options. A first data feed comprises present stock prices of the corporation. A second data feed comprises present risk-free interest rate structure. A processor is coupled to each of the databases and the first and second data feeds for receiving data from the databases and the first and second data feeds. The processor may be configured to extract from data stored in the databases at least one historical-based parameter affecting a valuation of employee stock options. A user interface is provided for communicating with the processor and perform a valuation of employee stock options at least in part based on the at least one historical-based parameter.

In another aspect thereof, the present invention further fulfills the foregoing needs by providing a computer system for performing valuation of stock options issued by a corporation to employees. The computer system may comprise a historical employee stock option database comprising information regarding employee stock option awards issued by the corporation. A historical stock price database comprises historical stock prices and dividends, if any, issued by the corporation. An employee database comprises information regarding employees who have been issued stock options. A first data feed comprises present stock prices of the corporation. A second data feed comprises present risk-free interest rate structure. A processor is coupled to each of the databases and the first and second data feeds for receiving data from the databases and the first and second data feeds. The processor may include a module for performing a valuation of employee stock options, wherein each stock option grant is processed as a series of sub-grants corresponding to a plurality of successive vesting epochs, and each subgrant is valued using a predefined valuation algorithm, with an effective maturity equal to a duration of a vesting epoch plus an expected lifetime after vesting.

### BRIEF DESCRIPTION OF THE DRAWINGS

The features and advantages of the present invention will become apparent from the following detailed description of the invention when read with the accompanying drawings in which:

FIG. 1 is a block diagram of one exemplary embodiment of a computer system embodying aspects of the present invention for performing valuation of employee stock options.

FIG. 2 is a representation of an exemplary user-interface screen comprising illustrative input and output data that may be processed and/or generated by the computer system of FIG. 1.

FIG. 3 is a plot that illustrates exemplary predicted stock price paths and an optimal exercise frontier, as may calculated by the computer system of FIG. 1, that, for example, take into account underlying value, interest rates, dividend payments, forfeiture and early exercise for estimating the value of ESOs.

### DETAILED DESCRIPTION OF THE INVENTION

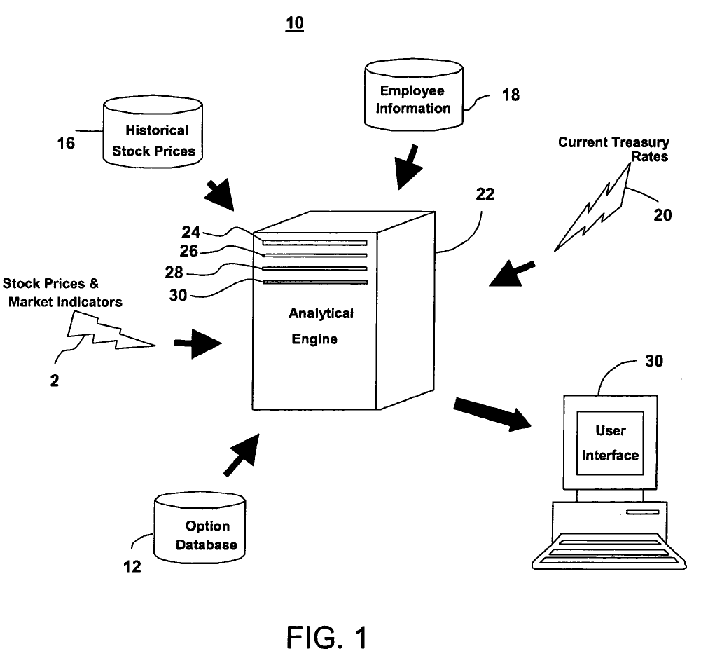

FIG. 1 is a block diagram of one exemplary embodiment of a computer system 10 embodying aspects of the present invention for performing valuation of stock options issued by a corporation to employees of that corporation. Computer system 10 may comprise the following elements: A historical employee stock option (ESO) database 12 comprising information, such as when each employee stock option award has been granted, and the corresponding option prices, vesting terms and schedule, restrictions, exercise history, etc. A first data feed 14, such as may comprise information essentially in real-time of present stock prices as well as market indicators. A historical stock price database 16 such as may comprise historical stock prices and dividends, if any, of the granting corporation. An employee database 18 comprising employee information, such as date of hire, job description, occupational rank, department, geographic location, date of termination (if applicable), etc. A second data feed 20, such as may comprise information essentially in real-time of present risk free rate structure, such as US Treasury rates. Computer system 10 further comprises a processor 22 or analytical engine that in turn includes a data integration unit 24 configured to interface and gather data from the foregoing sources of data. A data-mining unit 26 in processor 22 may be configured to enable automated or manual data exploration depending on the needs of a user. A forecasting unit 28 may be configured with any of various statistical and financial modeling tools to predict future stock prices. A result summarization unit 30 may be configured to provide summary information of analytical results obtained upon running the analytical engine. A user interface 30, such as a Web-enabled user interface, may be configured for interacting with processor 22 via a suitable communications network, such as the Internet, extranet, local area network, wide area network, etc. In this manner a user may, for example, remotely interact with the data-mining unit 26 and the result summarization unit 30 in the processor 22.

In operation, a stock option valuation is performed by the analytic engine 22 in cooperation with the other elements illustrated in FIG. 1, such as the various data sources and user interface. One of the advantageous aspects of the present invention is offering the user a computerized employee stock option valuation tool with a high degree of flexibility. More particularly, the analytical engine may be configured to offer the user a choice of several different alternative methods for performing data reduction and analysis functions. For example, the data-mining unit 26 may be configured to provide both automated and manual exploration of the source data.

Also, when operating in an off-line mode, the data-mining unit 26 may be configured to automatically look for patterns in each of the various source databases to identify and quantify factors that have a statistically significant correlation to option exercising activity. Examples of such influencing factors may include differences between present stock price and option price, geographic location, perceived and/or actual market conditions, relative prices of other financial instruments, treasury debt instrument yields, forfeiture rates, employee departure rates, etc. In addition the data-mining unit 26 may be configured to provide a real-time manual operation, enabling the user to quickly and effectively explore any of various possible data segmentations as may be chosen by the user.

In one exemplary embodiment, the forecasting unit 28 may be configured to utilize the information collected by the data-mining unit 26 to forecast a future value of the employee stock options awarded by a given corporation based on any of various economic and/or behavioral scenarios. Exemplary algorithms that may be used by the forecasting unit 28 include but are not limited to: Black-Scholes algorithms; Modified Binomial Lattice algorithms; Monte Carlo simulation methods; and Linear and Non-linear Regression models. For readers desirous of general background information regarding Black-Scholes and Binomial Tree Models, reference is made to Appendix A of paper titled “Determining the Value of Employee Stock Options,” by John Hull and Alan White, August 2002, which paper is incorporated by reference in its entirety herein.

One of the key purposes of employee stock options is to increase retention of employees perceived as highly valued to the granting corporation. Through the use of historical data that comprises information regarding employment and stock option grants, statistical models can be formulated in processor 22 to statistically quantify the retention effectiveness of stock option awards. For example, this may be accomplished by statistically quantifying whether employees to whom stock options are granted have a higher likelihood of staying with a company. To formulate such a model, one may draw an analogy to statistical reliability studies, likening employment termination (voluntary or involuntary) to a part's failure and leverage well-established reliability modeling techniques to correlate employment longevity relative to the award of stock options. See for example textbook titled “Statistical Methods for Reliability Data” by Meeker and Escobar, 1998 available from New York: Wiley, and herein incorporated by reference for background information regarding exemplary reliability modeling techniques. Thus, the inventors of the present invention have innovatively recognized computerized system and techniques that can be utilized not just for the valuation of employee stock options but also for quantifying the effectiveness of such stock option awards for retaining valuable employees.

In one exemplary application, such a model was used to analyze data on a sample of 1,749 individual comprising presently and formerly employed individuals at General Electric Company, 605 of whom were granted employee stock options and the remaining 1,144 were not. Employees who were still active at the time of the study and employees who had left due to retirement were treated as statistical suspensions (i.e., censored observations). The data from each group was found to substantially fit a lognormal distribution, and employees from the stock options group had an average length of employment of over twice as many years as that of the non-stock options group.

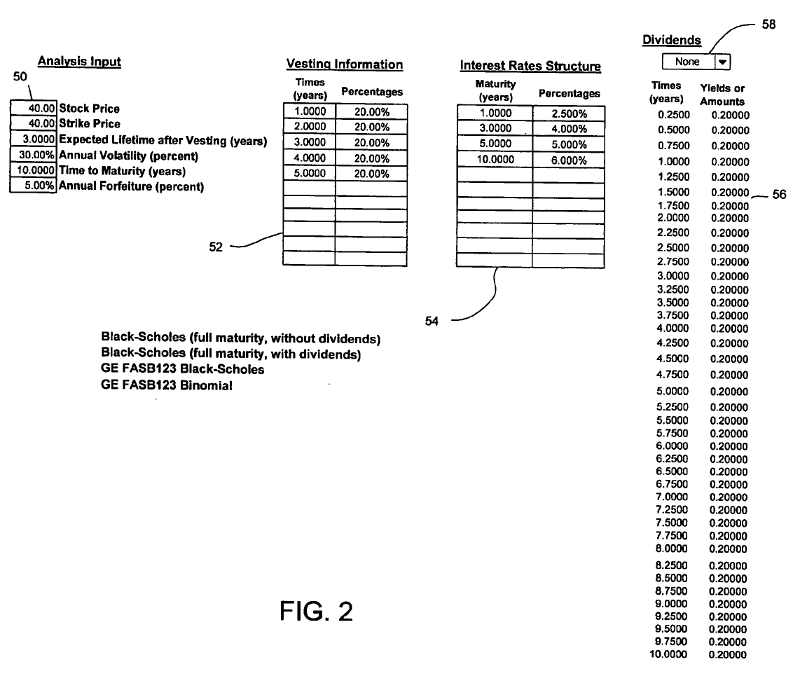

FIG. 2 is a representation of an exemplary screen as may be implemented with the user interface 30 (FIG. 1). An input window 50 may be used for inputting the following ESO parameters:
Stock Price. Price of underlying shares of stock at time of grant.
Strike Price. Price optionee will pay per share of stock if and when an option in the grant is exercised.
Expected Lifetime after Vesting. Average number of years that optionees wait after vesting until they exercise options. In one exemplary embodiment, this value is estimated from historical information about grants and exercises as may be stored in databases 12 and/or 18 (FIG. 1), and likely varies from company to company, and even between different cohorts in the same company. Suppose that, in a grant of 1,000 options, 400 vested 3 years after the grant date, and the remaining 600 vested 5 years after the grant date, and that the optionee chose to exercise all of the options 9 years after the grant date. If n denotes the total number of options in all the grants used to estimate average lifetime after vesting, then the options in this example contribute (9−3)×(400/n)+(9−5)×(600/n) to the overall average.
Annual Volatility. Annualized volatility of the underlying stock price: if s₁, . . . , sₘ denote stock prices at the end of each of m successive trading days, then in one exemplary embodiment this volatility may be estimated as \sqrt{252} times the standard deviation of log(s₂/s₁), log (s₃/s₂), . . . , log(sₘ/sₘ₋₁); and if a dividend Dᵢ should have been paid on the ith trading day prior to the market closing, then the term log(sᵢ/sᵢ₋₁) should be replaced by log((sᵢ+Dᵢ)/sᵢ₋₁).
Maturity. Option's contractual lifetime, in years.
Annual Forfeiture. The rate at which options expire worthless prior to vesting, such as when optionee leaves the company prior to vesting. In one exemplary embodiment the value of this parameter will be estimated from historical data, as may be stored in databases 12 and/or 18 (FIG. 1), in a manner consistent with the way the valuation procedure uses it: for example, if all options awarded to a particular class of optionees vest simultaneously 3 years after the grant date, and φ denotes the annual forfeiture rate for this class, then the forfeiture adjustment corresponds to the application of the discount factor (1−φ)³.

An input window 52 may be used for inputting the following vesting information parameters:
Times (Years). Epochs, in years, at which different portions of the grant vest.
Percentages. Percentages of the total number of options granted that vest at each of the specified vesting epochs.

An input window 54 may be used for entering term structure of risk-free, spot interest rates (e.g., U.S. Treasury or (London Interbank Offered Rate) LIBOR debt instruments, zero-coupon equivalents) that can be used to discount future dividends and stock prices to present value at grant date. Typical maturities for Treasury instruments may be 0.5, 1, 2, 3, 5, 7, 10 and 20 years. In general, the range of maturities listed here should cover the range of dividend epochs, and the option's time to maturity. In one exemplary embodiment, the valuation tool may be configured to interpolate a given term structure to obtain rates for any relevant, intermediate maturities.
Maturity (Years). Maturities for the term structure may be chosen so that the range of these maturities is broad enough so as to include all ex-dividend epochs (as may be specified in a window 56), and the epoch of contractual maturity (as may be specified in the time to maturity entry in window 50).
Percentages. Spot rates corresponding to the maturities specified, expressed as percentages.

A dropdown menu 58 may be used to define dividend characteristics, such as whether dividends correspond to dollar amounts, or percentage yields, or to indicate that there are none (None).

An input window 56 allows entering the following information regarding dividends:
Times (Years). Ex-dividend epochs: if the last ex-dividend epoch should coincide with the option's maturity, it is treated as immediately preceding it.
Yield or Amount. Dividends expected to be paid at the specified ex-dividend epochs.

Below is a description of exemplary valuation outputs from analytical engine 22:
Exemplary ESO Valuation Choices. Conventional Black-Scholes valuations of comparable European options, with or without consideration of dividends, may be included for comparison with a valuation embodying aspects of the present invention (referred to as GE FASB123). This technique values options that vest at different epochs separately, and then combines such individual valuations using a suitable averaging technique, such as a weighted average. For each vesting epoch, this technique takes into account factors such as maturity, volatility, and forfeiture. Maturity may be characterized as Vesting period plus Expected lifetime after vesting. One desirable feature is to capture characteristics of early exercise as may be extracted from a historically based estimation of Expected lifetime after vesting.

Forfeiture may be characterized as compound forfeiture rate over vesting period and may comprise an historical average for expired grants, approximately 5% per year for General Electric Company. One exemplary valuation technique may be a binomial tree for an American call type of option modified to incorporate vesting restriction on early exercise. Other advantages of this valuation technique is the recognition that stock prices may undergo random jumps superimposed on geometric Brownian motion (generally referred in the field as Merton's Jump-Diffusion), or perhaps exhibit other complex behavior. This valuation technique further recognizes that stock price volatility together with term-structure of risk-free interest rate and dividend amounts, if any, are highly unlikely to remain constant over the relatively long periods associated with ESO's typical maturity periods. Accordingly, this valuation technique in one exemplary embodiment may use a jump-diffusion model that stochastically accounts for volatility regarding the temporal evolution of stock prices.
Black-Scholes (full maturity, without dividends). This valuation choice treats the options as exchange-traded European calls with maturity equal to their contractual maturity (as specified in window 52), disregarding dividends. Expected lifetime after vesting, vesting schedule and anticipated dividends, is each ignored in this calculation.
   Example A. Stock price and strike price both equal to $40, expected lifetime after vesting and time to maturity set to 10 years, 30% annual volatility, 0% annual forfeiture, vesting 100% at 0 years, flat interest rate term structure (5% for 1 year and 10 year maturities):
Valuation result with Black-Scholes (full maturity, without dividends)=$21.03.
Black-Scholes (full maturity, with dividends). This valuation choice treats the options as exchange-traded European calls with maturity equal to their contractual maturity (as specified in window 52), and paying dividends as specified in window 56. Expected lifetime after vesting, and vesting schedule are ignored in this calculation.
   Example B. Same inputs as Example A, with quarterly dividends of 0.5%: Valuation result=$15.11. This result is obtained by applying Black-Scholes' formula assuming that dividends are paid continuously at a 2% yearly rate.
   Example C. Same inputs as Example A, with quarterly dividends of $0.20: Valuation result=$17.57. If S₀ denotes the stock price on the grant date, D denotes the net present value of all future dividends, and σ denotes the stock price's annual volatility, then this result is obtained by applying Black-Scholes' formula with the stock price set to S0−D, the volatility inflated to σS₀/(S₀−D), and the continuous dividend yield set to 0%.

GE FASB123 Black-Scholes. This valuation choice treats the grant as a series of sub-grants corresponding to the different vesting epochs, and values options in each sub-grant by applying Black-Scholes's formula as performed in Examples B and C, depending on whether dividends are expressed as yields or amounts, with effective maturity equal to the duration of the vesting period plus the expected lifetime after vesting.

Each sub-grant's valuation is discounted by a factor of the form (1−φ)^{v}, where φ denotes the forfeiture rate, and v denotes the duration of the corresponding vesting period; the several sub-grant valuations finally are combined into a weighted average with the vesting proportions as weights.

If the effective maturity of any sub-grant, computed as described above, should exceed the option's contractual maturity, then it will be truncated to equal the latter value.
Example D. Stock price and strike price both equal to $40, 3 years expected lifetime after vesting, 10 years time to maturity, 30% annual volatility, 5% annual forfeiture, vesting 20% at the end of each of the first five years after grant date, interest rate term structure {(1 yr, 2.5%), 3 yr, 4%), (5 yr, 5%), (10 yr, 6%)}, and quarterly dividends of $0.20:
GE FASB123 Black-Scholes Resulting Valuation=$11.80.
GE FASB123 Binomial. This valuation choice also treats the grant as a series of sub-grants corresponding to the different vesting epochs, and values options in each sub-grant using a vesting restricted binomial tree for an American call on dividends-paying stock whose price evolves according to geometric Brownian motion, with effective maturity equal to the duration of the vesting period plus the expected lifetime after vesting, and including a forfeiture discount. The various sub-grant valuations are combined into a weighted average with the vesting proportions as weights.
   Example E. Same inputs as Example D:
GE FASB123 Binomial Resulting Valuation=$11.10.

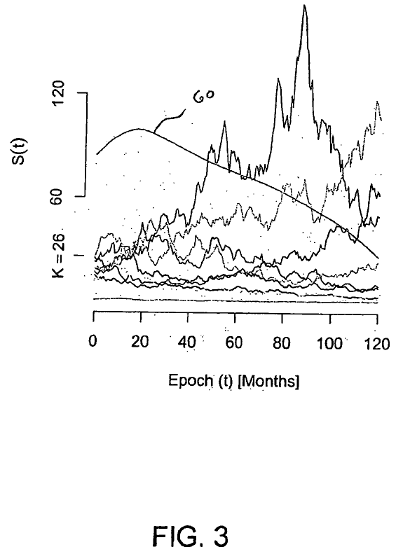

FIG. 3 is a plot that illustrates exemplary predicted stock price paths and an optimal exercise frontier 60, as may calculated by processor 22 (FIG. 1), that, for example, take into account underlying value, interest rates, dividend payments, forfeiture and early exercise and provides a substantially flexible approach for accurately and consistently estimating the value of ESOs.

Aspects of the present invention demonstrate that the fair valuation of ESOs is possible through the use of financial and statistical tools. Also specific historical data that is tailored to a target population of grantees may provide information that is highly relevant for fair and accurate valuation. Example of such information may be forfeiture rate, expected lifetime of option after vesting. Aspects of the present invention offer a statistical approach of ESO valuations, based on valuation functions adaptively estimated on historical data. The resulting valuations are independent of artificially fixed financial assumptions and can accommodate varying economic and behavioral scenarios. Valuations based on simulation of predicted paths of underlying value, interest rates, dividend payments, forfeiture and early exercise when combined with a pre-defined optimal exercise frontier offers a substantially flexible approach for accurately estimating the value of ESOs.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A computer system for performing valuation of stock options issued by a corporation to employees, said computer system comprising:
a historical employee stock option database comprising information regarding employee stock option awards issued by said corporation;
a historical stock price database comprising historical stock prices and dividends, if any, issued by said corporation;
an employee database comprising information regarding employees who have been issued stock options;
a first data feed comprising present stock prices of said corporation;
a second data feed comprising present risk-free interest rate structure;
a processor coupled to each of said databases and said first and second data feeds for receiving data from said databases and said first and second data feeds, said processor configured to extract from data stored in said databases at least one historical-based parameter affecting a valuation of employee stock options; and
a user interface for communicating with said processor and perform a valuation of employee stock options at least in part based on said at least one historical-based parameter.

2. The computer system of claim 1 wherein the historical-based parameter affecting a valuation of employee stock options comprises annual forfeiture of employee stock options.

3. The computer system of claim 1 wherein the historical-based parameter affecting a valuation of employee stock options comprises expected lifetime of employee stock options after vesting.

4. The computer system of claim 1 further comprising a data-mining module having a mode of operation based on criteria manually defined by a user.

5. The computer system of claim 1 further comprising a data mining module having an automated mode of operation based on predefined criteria stored in memory.

6. The computer system of claim 1 wherein said processor includes at least one forecasting model for performing a valuation of employee stock options, said at least one forecasting model selected from the group consisting of Black-Scholes, binomial lattice, Monte Carlo and Linear and Non-linear Regression models.

7. The computer system of claim 1 wherein said processor further comprises a statistical model for quantifying an effect of stock option awards upon employee retention.

8. A computer system for performing valuation of stock options issued by a corporation to employees, said computer system comprising:
a historical employee stock option database comprising information regarding employee stock option awards issued by said corporation;
a historical stock price database comprising historical stock prices and dividends, if any, issued by said corporation;
an employee database comprising information regarding employees who have been issued stock options;
a first data feed comprising present stock prices of said corporation;
a second data feed comprising present risk-free interest rate structure; and
a processor coupled to each of said databases and said first and second data feeds for receiving data from said databases and said first and second data feeds, said processor including a module for performing a valuation of employee stock options, wherein each stock option grant is processed as a series of sub-grants corresponding to a plurality of successive vesting epochs, and each subgrant is valued using a predefined valuation algorithm, with an effective maturity equal to a duration of a vesting epoch plus an expected option lifetime after vesting.

9. The computer system of claim 8 wherein each sub-grant's valuation is discounted by a factor characterized by (1−φ)^{v}, where φ denotes a forfeiture rate, and v denotes a duration of the corresponding vesting epoch.

10. The computer system of claim 8 wherein the module for performing a valuation of employee stock options combines the plurality of sub-grant valuations using a weighted average.

11. The computer system of claim 10 wherein a plurality of vesting proportion values comprises weight values for performing said weighted average.

12. The computer system of claim 8 wherein said processor further comprises a statistical model for quantifying an effect of stock option awards upon employee retention.

13. The computer system of claim 8 further comprising a data-mining module configured to extract from data stored in said databases at least one historical-based parameter affecting a valuation of employee stock options.

14. The computer system of claim 13 wherein the expected option lifetime after vesting constitutes the historical-based parameter affecting the valuation of employee stock options.

15. A computerized method for performing valuation of stock options issued by a corporation to employees, said method comprising:
populating a historical employee stock option database with information regarding employee stock option awards issued by said corporation;
populating a historical stock price database with historical stock prices and dividends, if any, issued by said corporation;
populating an employee database with information regarding employees who have been issued stock options;
providing a first data feed comprising present stock prices of said corporation;
providing a second data feed comprising risk-free interest rate structure;
extracting from data stored in said databases at least one historical-based parameter affecting a valuation of employee stock options; and
performing a valuation of employee stock options at least in part based on said at least one historical-based parameter.

16. The computerized method of claim 15 further comprising measuring an effect of stock option awards upon employee retention.

17. A computerized method for performing valuation of stock options issued by a corporation to employees, said method comprising:
populating a historical employee stock option database with information regarding employee stock option awards issued by said corporation;
populating a historical stock price database with historical stock prices and dividends, if any, issued by said corporation;
populating an employee database with information regarding employees who have been issued stock options;
providing a first data feed comprising present stock prices of said corporation;
providing a second data feed comprising present risk-free interest rate structure; and performing a valuation of employee stock options, wherein each stock option grant is processed as a series of sub-grants corresponding to a plurality of successive vesting epochs, and each subgrant is valued using a predefined valuation algorithm, with an effective maturity equal to a duration of a vesting epoch plus an expected option lifetime after vesting.

18. The computerized method of claim 17 wherein each sub-grant's valuation is discounted by a factor characterized by (1−φ)^{v}, where φ denotes a forfeiture rate, and v denotes a duration of the corresponding vesting epoch.

19. The computerized method of claim 17 further comprising performing a valuation of employee stock options by combining the plurality of sub-grant valuations using a weighted average.

20. The computerized method of claim 17 further comprising measuring an effect of stock option awards upon employee retention.
